(19) United States
(12) Patent Application Publication
(10) Pub. No.: US 2022/0033321 A1
(43) Pub. Date: Feb. 3, 2022

(54) SOLID WASTE TREATMENT SYSTEM

(71) Applicant: BEIJING GREENTECH SCIENCE AND TECHNOLOGY CO., LTD., Beijing (CN)

(72) Inventors: Shufang ZHANG, Beijing (CN); Haixia ZHENG, Beijing (CN); Xinming WANG, Beijing (CN); Chunlin LIANG, Beijing (CN); Jingwei ZHANG,, Beijing (CN)

(21) Appl. No.: 17/298,824

(22) PCT Filed: Oct. 29, 2019
(86) PCT No.: PCT/CN2019/113915

§ 371 Date: Jun. 1, 2021

(30) Foreign Application Priority Data
Jan. 21, 2019 (CN) 201910054883.7

(51) Int. Cl. C05F 17/20; C05F 9/00; C05F 17/921; C05F 17/964; C05F 17/90

(52) U.S. Cl. CPC C05F 17/20; C05F 9/00; C05F 17/989; C05F 17/964; C05F 17/939

(57) ABSTRACT

An exemplary solid waste treatment system can be provided which can include a storage device, an intelligent aerobic fermentation treatment device, a retaining wall-type fermentation area, and an aeration platform. The intelligent aerobic fermentation treatment device can include a traveling trolley, a lifting mechanism, a material pick-and-place mechanism, and a traveling bridge linearly moving in a direction away from the storage device towards the retaining wall-type fermentation area. The aeration platform can be arranged at the bottom of the retaining wall-type fermentation area. The traveling trolley linearly can move on the traveling bridge in a direction perpendicular to the direction away from the storage device towards the retaining wall-type fermentation area. The lifting mechanism can be mounted on the traveling trolley. The material pick-and-place mechanism can be suspended on the lifting mechanism to be raised and lowered in step with the raising and lowering of the lifting mechanism.

This application claims the priority to Chinese patent application No. 201910054883.7, titled “SOLID WASTE TREATMENT SYSTEM”, filed with the China National Intellectual Property Administration on Jan. 21, 2019, which is incorporated herein by reference in its entirety.

### FIELD

The present application relates to the technical field of solid waste treatment equipment, and in particular to a solid waste treatment system.

### BACKGROUND

With the continuous advancement of urbanization and the continuous improvement of environmental protection requirements in China, the problem of safe disposal of organic solid waste has become increasingly prominent. Aerobic fermentation is an important way for harmless treatment of solid wastes such as sludge, garbage and feces. At present, the aerobic fermentation treatment of organic solid waste in China is mainly performed in the manner of windrow composting and trough composting, which has problems such as long composting time and difficult odor control. In addition, due to the large occupied area and high cost of construction, it is difficult for windrow composting system and trough composting to meet the needs of small and medium sized solid waste plant. Therefore, it is urgent to develop a composting reactor applicable to aerobic fermentation treatment of small and medium sized solid waste plant.

At present, the development trend of aerobic fermentation technology at home and abroad is to develop hermetical and environment-friendly reactor composting system. The research and development of reactor composting system in China is still in the initial stage, and the lifting and transportation of materials needed for fermentation in the aerobic fermentation process are completely done by manpower, resulting in low efficiency of the solid waste treatment.

### SUMMARY

An object of the present application is to provide a solid waste treatment system which has a high efficiency in treating the solid waste.

In order to achieve the above object, the following technical solutions are provided according to the present application.

According to one aspect of the present application, a solid waste treatment system is provided, including a storage device, an intelligent aerobic fermentation treatment device, a retaining wall type fermentation region, and an aeration platform; the intelligent aerobic fermentation treatment device includes a traveling trolley, a lifting mechanism, a material pick-up and discharge mechanism, and a traveling bridge that moves linearly along a direction from the storage device to the retaining wall type fermentation region;

the aeration platform is arranged at a bottom of the retaining wall type fermentation region;

the traveling trolley is configured to move linearly on the traveling bridge along a direction perpendicular to the direction from the storage device to the retaining wall type fermentation region;

the lifting mechanism is arranged at the traveling trolley;

the material pick-up and discharge mechanism is hung on the lifting mechanism, so as to be able to be lifted or lowered together with the lifting mechanism.

Further, the lifting mechanism includes an upper frame, a lower frame, a scissor structure and a first driving mechanism:

the upper frame is arranged at the traveling trolley; the lower frame is connected with the upper frame through the scissor structure, and the driving mechanism is connected with the scissor structure; and

the material pick-up and discharge mechanism is hung on the lower frame, so as to be able to be lifted or lowered together with the lower frame.

Further, the material pick-up and discharge mechanism includes a storage hopper, a plurality of pick-up shovels, a transmission chain structure, and a second driving mechanism; wherein

the storage hopper includes a hopper body with an opened top and a discharge door;

the discharge door is movably arranged at a bottom of the hopper body;

the hopper body is hung on the lower frame; the plurality of pick-up shovels are arranged around the hopper body via the transmission chain structure; and the transmission chain structure is connected with the second driving mechanism.

Further, the retaining wall type fermentation region includes a closed fence type retaining wall, and the retaining wall type fermentation region is defined by the fence type retaining wall.

Further, the fence type retaining wall includes a plurality of sub retaining walls fixedly connected with the ground, and the plurality of sub retaining walls are connected to form the closed fence type retaining wall.

Further, the aeration unit includes a plurality of aeration units, each of the aeration units includes a base, an aeration plate arranged at the bottom of the retaining wall type fermentation region, and an aeration head in communication with the retaining wall type fermentation region; and wherein

the base includes two sub-bases arranged opposite to each other, and an air inlet channel is formed between the two sub-bases;

each two adjacent aeration units are spliced to each other;

the aeration plate is located between the two sub-bases and is detachably mounted on the two sub-bases;

the aeration plate is provided with an air hole, the aeration head which is corresponding to the air hole is detachably mounted on the aeration plate, and the aeration head is in communication with the air hole.

Further, the storage device includes an auxiliary material buffer region, a sludge buffer region, and a finished material buffer region which are independent from one another.

Further, the solid waste treatment system further includes a purification device, wherein an outlet of the purification device is in communication with the aeration platform, and an outlet of the purification device is in communication with the retaining wall type fermentation region.

Further, the purification device includes a plurality of first suction devices, a first pipeline and a gas-water separator;

the plurality of first suction devices and the gas-water separator are connected in series in the first pipeline, and are all in communication with the first pipeline;

the retaining wall type fermentation region is in communication with the gas-water separator, to allow a hot and humid gas generated in the retaining wall type fermentation region to be sent into the gas-water separator by the first suction device for gas-water separation;

the gas-water separator is in communication with the aeration platform, to allow a hot gas separated by the gas-water separator to be sent to the aeration platform by the first suction device for aeration.

Further, the solid waste treatment system includes a fermentation cabin; wherein

the fermentation cabin covers is arranged to cover the storage device, the intelligent aerobic fermentation treatment device, the retaining wall type fermentation region, the aeration platform and the purification device; and

the intelligent aerobic fermentation treatment device is configured to travel on a bottom surface of the fermentation cabin.

According to the solid waste treatment system of the present application, the solid waste treatment system is controlled by an automatic control system in the solid waste treatment process, and the movement of the intelligent aerobic fermentation treatment device is controlled by the automatic control system. In the process that solid wastes are treated by the solid waste treatment system, the automatic control system may control the traveling bridge to move linearly along the direction from the storage device to the retaining wall type fermentation region, control the traveling trolley to move linearly on the traveling bridge along the direction perpendicular to the direction from the storage device to the retaining wall type fermentation region, control the lifting mechanism to drive the material pick-up and discharge mechanism to move up or down, and control the material pick-up and discharge mechanism to pick up materials and discharge the materials into the retaining wall type fermentation region. Therefore, the traveling bridge, traveling trolley and lifting mechanism realize automatic movement in the three-dimensional space, and the material pick-up and discharge mechanism may be controlled by the automatic control system to realize automatic material picking and automatic material discharging into the retaining wall type fermentation region. The material pick-up and discharge mechanism is able to move automatically in the three-dimensional space, and the material pick-up and discharge mechanism is able to automatically pick up materials and discharge materials into the retaining wall type fermentation region, hence, the material pick-up and discharge mechanism is able to automatically and accurately move the materials into the retaining wall type fermentation region, which avoids pure manual lifting and conveying of the materials, and thereby improving the efficiency of solid waste treatment.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a schematic view showing the structure of a solid waste treatment system according to an embodiment of the present application,

FIG. 2 is a schematic view showing the structure of a lifting mechanism of the solid waste treatment system according to the embodiment of the present application;

FIG. 3 is a schematic view showing the structure of a material pick-up and discharge mechanism of the solid waste treatment system according to the embodiment of the present application;

FIG. 4 is a schematic view showing the structure of a retaining wall type fermentation region of the solid waste treatment system according to the embodiment of the present application:

FIG. 5 is a schematic view showing the structure of an aeration unit of the solid waste treatment system according to the embodiment of the present application;

FIG. 6 is a schematic view showing the structure of the aeration unit of the solid waste treatment system according to the embodiment of the present application; and

FIG. 7 is a schematic view showing the structure of a purification device of the solid waste treatment system according to the embodiment of the present application.

### REFERENCE NUMERALS

| | | | |
|---|---|---|---|
| 10 | storage device, | 101 | auxiliary material |
| | | | buffer region, |
| 102 | sludge buffer region, | 103 | finished material |
| | | | buffer region, |
| 20 | intelligent aerobic fermentation | | |
| | treatment device, | | |
| 201 | traveling bridge, | 202 | traveling trolley, |
| 203 | lifting mechanism, | 2031 | upper frame, |
| 2032 | scissor structure, | 2033 | lower frame, |
| 204 | material pick-up and discharge | | |
| | mechanism, | | |
| 2041 | hopper body, | 2042 | pick-up shovel, |
| 2043 | transmission chain structure, | 30 | retaining wall type |
| | | | fermentation region, |
| 301 | fence type retaining wall, | 3011 | sub retaining wall, |
| 40 | aeration platform, | 401 | aeration unit, |
| 4011 | sub base, | 4012 | slot, |
| 4013 | protrusion, | 4014 | aeration plate, |
| 4015 | aeration head, | 4016 | support column, |
| 50 | purification device, | 501 | first pipeline, |
| 502 | gas-water separator, | 503 | second pipeline, |
| 504 | waste gas collection pipe, | 505 | washing tower, |
| 506 | third pipeline, | 507 | water processor, |
| 508 | water collection tank, | 60 | fermentation cabin, |
| 70 | automatic control system. | | |

### DETAILED DESCRIPTION OF THE EMBODIMENTS

Technical solutions according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of protection of the present application.

In the description of the present application, it should be noted that the orientation or positional relationships indicated by terms such as “center”, “up”, “down”, “left”, “right”, “vertical”, “horizontal”. “inner”, “outer”, and the like are based on the orientation or positional relationships shown in the drawings, and are merely for the convenience of describing the present application and the simplification of the description, and do not indicate or imply that the device or element referred to must have a particular orientation, or be configured and operated in a particular orientation, which therefore should not be construed as a limitation to the scope of the present application. In addition, terms such as “first”, “second”, “third” and the like are merely for description, and should not be construed as indicating or implying relative importance.

In the description of the present application, it should be noted that, unless otherwise defined and specified, terms such as “mount”. “joint” and “connection” should be understood in a broad sense, for example, the terms may refer to a fixed connection, a detachable connection or an integral connection; may be a mechanical connection or an electrical connection; and may be a direct connection or an indirect connection via an intermediate media, or communication between insides of two components. For those skilled in the art, the specific meaning of the above terms in the present application may be understood according to specific circumstances.

### Embodiment

A solid waste treatment system is provided according to one aspect of the present application. As shown in FIG. 1, the solid waste treatment system includes a storage device 10, 10j an intelligent aerobic fermentation treatment device 20, a retaining wall type fermentation region 30, and an aeration platform 40; wherein

the intelligent aerobic fermentation treatment device 20 includes a traveling trolley 202, a lifting mechanism 203, a material pick-up and discharge mechanism 204, and a traveling bridge 201 configured to move linearly along a direction from the storage device 10 to the retaining wall type fermentation region 30;

the aeration platform 40 is arranged at a bottom of the retaining wall type fermentation region 30;

the traveling trolley 202 is configured to move linearly on the traveling bridge 201 along a direction perpendicular to the direction from the storage device 10 to the retaining wall type fermentation region 30;

the lifting mechanism 203 is arranged at the traveling trolley 202; and

the material pick-up and discharge mechanism 204 is hung on the lifting mechanism 203, so as to be lifted or lowered together with the lifting mechanism 203.

According to the solid waste treatment system of the present application, the solid waste treatment system is controlled by an automatic control system 70 in the solid waste treatment process, and the movement of the intelligent aerobic fermentation treatment device 20 is controlled by the automatic control system 70. In the process that solid wastes are treated by the solid waste treatment, the automatic control system 70 may control the traveling bridge 201 to move linearly along the direction from the storage device 10 to the retaining wall type fermentation region 30, control the traveling trolley 202 to move linearly on the traveling bridge 201 along the direction perpendicular to the direction from the storage device 10 to the retaining wall type fermentation region 30, control the lifting mechanism 203 to drive the material pick-up and discharge mechanism 204 to move up or down, and control the material pick-up and discharge mechanism 204 to pick up materials and discharge the materials into the retaining wall type fermentation region 30. Therefore, the traveling bridge 201, traveling trolley 202 and lifting mechanism 203 realize automatic movement in the three-dimensional space, and the material pick-up and discharge mechanism 204 may be controlled by the automatic control system to realize automatic material picking and automatic material discharging into the retaining wall type fermentation region. The material pick-up and discharge mechanism 204 is able to move automatically in the three-dimensional space, and the material pick-up and discharge mechanism 204 is able to automatically pick up materials and discharge materials into the retaining wall type fermentation region, hence, the material pick-up and discharge mechanism 204 is able to automatically and accurately move the materials into the retaining wall type fermentation region 30, which avoids pure manual lifting and conveying of the materials, and thereby improving the efficiency of solid waste treatment.

It should be noted that, the traveling bridge 201 and the traveling trolley 202 are each provided with a driving mechanism which can drive the traveling bridge 201 or the traveling trolley 202 to move, the driving mechanism may include belt drive and a motor or include gear drive and a motor, and the automatic control system 70 is electrically connected with the motor.

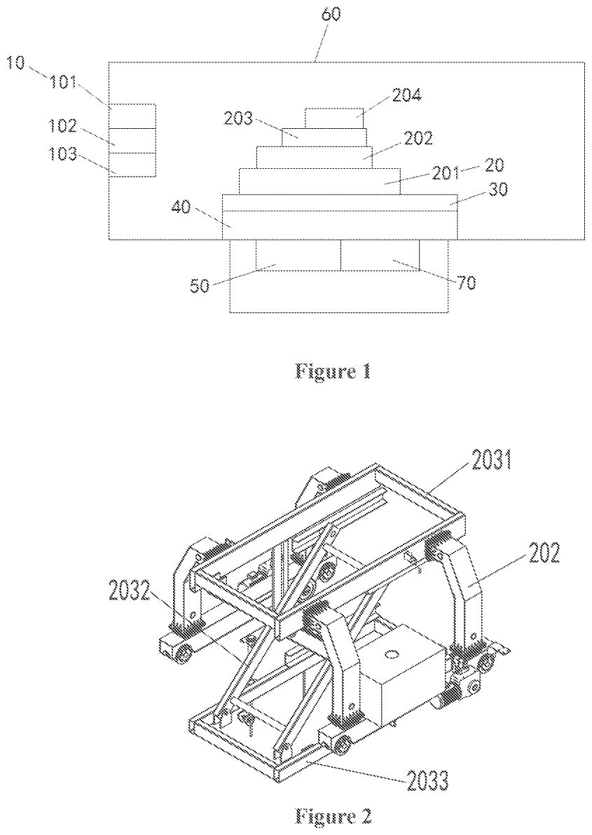

According to one solution of the solid waste treatment system of the present application, as shown in FIG. 2, the lifting mechanism 203 includes an upper frame 2031, a lower frame 2033, a scissor structure 2032 and a first driving mechanism;

the upper frame 2031 is mounted at the traveling trolley 202, the lower frame 2033 is connected with the upper frame 2031 through the scissor structure 2032, and the driving mechanism is connected with the scissor structure 2032; and

the material pick-up and discharge mechanism 204 is hung on the lower frame 2033, so as to be lifted or lowered together with the lower frame 2033.

According to the solid waste treatment system of the present application, the lifting mechanism 203 is mainly configured for making the material pick-up and discharge mechanism 204 be lifted or lowered in a process that the material pick-up and discharge mechanism 204 obtains materials required by fermentation and discharges the materials into the retaining wall type fermentation region 30, to enable the material pick-up and discharge mechanism 204 to seek a suitable height for picking and a suitable height for discharging;

when the lifting mechanism 203 is in operation, the automatic control system controls the 10, first driving mechanism, and the first driving mechanism drives the scissor structure 2032 to be expanded or retracted, to make the lower frame 2033 lifted or lowered, thereby making the material pick-up and discharge mechanism 204 lifted or lowered.

The first driving mechanism includes an oil cylinder.

Specifically, the scissor structure 2032 includes a first oblique beam and a second oblique beam arranged in a crossing manner, and the first driving mechanism is respectively connected with the first oblique beam and the second oblique beam.

The first driving mechanism includes two oil cylinders, the first oblique beam is connected with one oil cylinder, and the second oblique beam is connected with the other oblique beam.

The first driving mechanism synchronously controls the two oil cylinders, to make the first oblique beam and the second oblique beam be lifted or lowered at the same time, so as to realize the expansion or retraction of the scissor structure 2032.

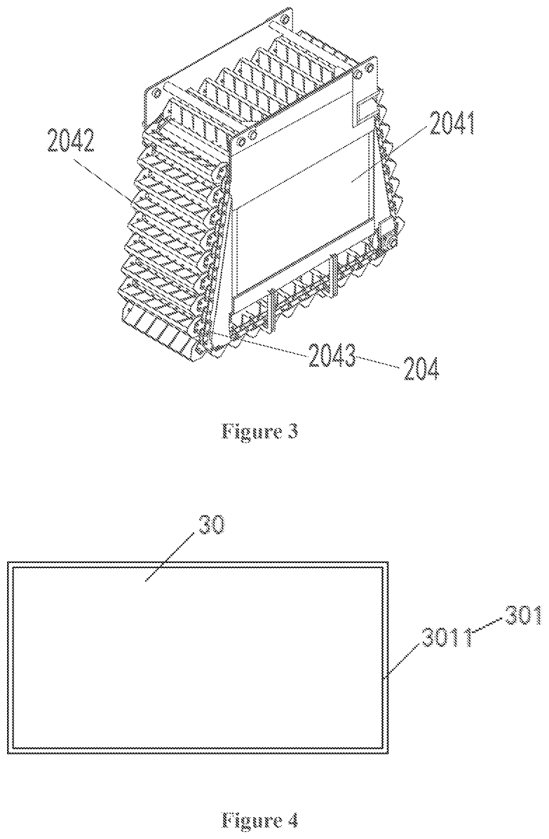

According to one solution of the solid waste treatment system of the present application, as shown in FIG. 3, the material pick-up and discharge mechanism 204 includes a storage hopper, a plurality of pick-tip shovels 2042, a transmission chain structure 2043 and a second driving mechanism; wherein

the storage hopper includes a hopper body 2041 with an opened top, and a discharge door.

the discharge door is movably arranged at a bottom of the hopper body 2041; and

the hopper body 2041 is hung on the lower frame 2033, the plurality of pick-up shovels 2042 are arranged around the hopper body 2041 via the transmission chain structure 2043, and the transmission chain structure 2043 is connected with the second driving mechanism.

According to the solid waste treatment system of the present application, the discharge door is movably arranged at the bottom of the hopper body 2041, so that the discharge door can be opened or closed relative to the hopper body 2041, to realize the material discharging. Specifically, one side of the discharge door may be connected with the hopper body 2041 through a hinge structure, and another side of the discharge door may be controlled by a crank-rocker structure to make the discharge door be opened or closed relative to the hopper body 2041, and the crank-rocker structure is controlled by the automatic control system 70.

The second driving mechanism is a motor, and the motor is controlled by the automatic control system 70, to enable a chain in the transmission chain structure 2043 to realize forward and backward movements.

Preferably, the pick-up shovels 2042 are arranged on an outer ring of the transmission chain structure 2043 in a manner that the pick-up shovels are perpendicular to a transmission direction of the transmission chain structure 2043.

On the basis that the pick-up shovels 2042 are arranged on the outer ring of the transmission chain structure 2043 in a manner that the pick-up shovels are perpendicular to the transmission direction of the transmission chain structure 2043, the pick-up shovels 2042 are arranged in a manner that an opening of each of the pick-up shovels 2042 faces a direction parallel to the transmission direction of the transmission chain structure 2043. When the pick-up shovels 2042 are driven by the transmission chain structure 2043 to move to the bottom of the hopper body 2041, the pick-up shovels 2042 are required to be able to shovel the solid wastes to a large extent; and when the pick-up shovels 2042 move to the top of the hopper body 2041, the pick-tip shovels 2042 are required to be able to discharge the solid wastes in the shovel to a large extent. Therefore, with comprehensive consideration, it is preferable that the opening of the pick-tip shovel 2042 faces the direction parallel to the transmission direction of the transmission chain structure 2043.

For the material pick-up and discharge mechanism 204, for example, in a case that the material is sludge, when the material pick-up and discharge mechanism 204 picks up the sludge, the motor drives the transmission chain structure 2043 to move, the movement of the transmission chain structure 2043 drives the plurality of pick-up shovels 2042 to move around the hopper body 2041 to realize material picking; and when the pick-up shovels 2042 moves to the top of the hopper body 2041, the sludge in the pick-up shovels 2042 freely falls into the hopper body 2041. When the sludge in the material pick-up and discharge mechanism 204 is moved to a position of the retaining wall type fermentation region 30 by the cooperative action of the traveling bridge 201, the traveling trolley 202 and the lifting mechanism 203, the discharge door is opened, the sludge in the hopper body 2041 is dumped into the retaining wall type fermentation region 30, and thereby the material picking and discharging are realized by the material pick-up and discharge mechanism 204.

In addition, in a case that the sludge is required to be turned, the transmission chain structure 2043 drives the plurality of pick-up shovels 2042 to move around the hopper body 2041, when the pick-up shovels 2042 come into contact with the sludge in the retaining wall type fermentation region 30 which is located at a bottom, the pick-up shovels 2042 shovel the sludge; and when the pick-up shovels 2042 rotate to the top of the hopper body 2041, the sludge in the pick-up shovels 2042 freely falls into the hopper body 2041, until the whole hopper body is filled with the sludge. After the whole hopper body is filled with the sludge, the sludge is directly conveyed by the pick-up shovels 2042 and thrown down to a rear position of travelling, thus the turning over of the sludge is completed.

In a case that the sludge in the retaining wall type fermentation region 30 is required to be conveyed away, the discharge door is closed, and the transmission chain structure 2043 drives the plurality of pick-up shovels 2042 to move around the hopper body 2041. When the pick-up shovels 2042 come into contact with the sludge in the retaining wall type fermentation region 30 which is located at the bottom, the pick-up shovels 2042 shovel the sludge; and when the pick-up shovels 2042 rotate to the top of the hopper body 2041, the sludge in the pick-up shovels 2042 is dumped into the hopper body 2041, thus conveying the sludge away from the retaining wall type fermentation region 30.

Therefore, under the cooperative action of the traveling bridge 201, the traveling trolley 202 and the lifting mechanism 203, the material pick-up and discharge mechanism can complete the above-mentioned functions of material picking, discharging, turning over and transfer.

The number of the pick-up shovels 2042 is multiple, the multiple pick-up shovels 2042 are arranged on the outer ring of the transmission chain structure 2043 at equal intervals, the multiple pick-up shovels 2042 work together to perform material picking, discharging, turning over and transfer, and thus the working efficiency is high.

It should be noted that the pick-up shovels 2042 at the bottom of the hopper body 2041 will not affect the opening and closing of the discharge door, because the discharge door is embodied as multiple doors, and enough space for opening and closing the discharge door is provided due to an interval provided between each two of the pick-up shovels 2042.

According to one solution of the solid waste treatment system of the present application, as shown in FIG. 4, the retaining wall type fermentation region 30 includes a closed fence type retaining wall 301, and the retaining wall type fermentation region 30 is defined by the closed fence type retaining wall 301.

According to one solution of the solid waste treatment system of the present application, the closed fence type retaining wall 301 includes a plurality of sub retaining walls 3011 fixedly connected with the ground, and the plurality of sub retaining walls 3011 are connected to form the closed fence type retaining wall 301.

According to the solid waste treatment system of the present application, the retaining wall type fermentation region may be formed by the integral closed fence type retaining wall 301, or may be formed by an enclosure in which the plurality of sub retaining walls 3011 are connected.

For the closed fence fermentation region, the automatic control system controls the traveling bridge to travel, and may control the traveling bridge to travel within a certain range by virtue of sensors such as locators and the like, that is, control the traveling bridge to stop travelling forward after traveling for a certain distance. During the traveling process of the traveling bridge, the automatic control system controls the lifting mechanism and the material pick-up and discharge mechanism to place the materials to be fermented in the retaining wall type fermentation region within a traveling range of the traveling bridge, and make the materials to be fermented be in a shape of a tapered stack, to allow the batch of materials to ferment in this region. When another batch of materials to be fermented is conveyed to the retaining wall type fermentation region, the materials to be fermented are made to form another tapered stack under the control of the automatic control system, so that the another batch of materials to be fermented will not affect the fermentation of the previous batch of materials. By analogy, a plurality of different batches of tapered stack can be formed in the retaining wall type fermentation region, and thus the space in the retaining wall type fermentation region can be reasonably utilized.

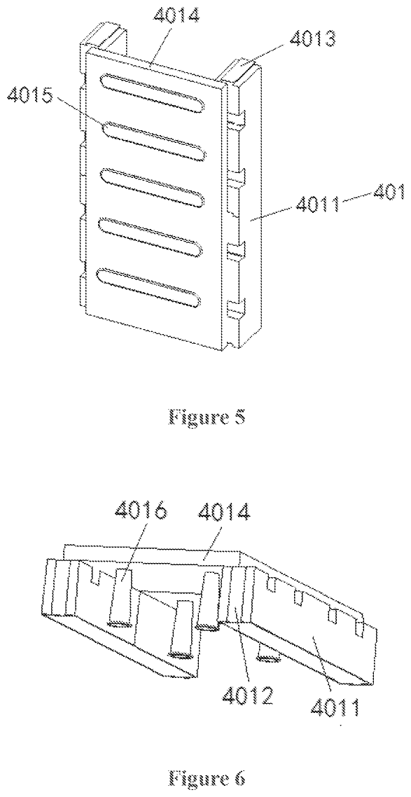

According to one solution of the solid waste treatment system of the present application, as shown in FIGS. 5 and 6, the aeration platform 40 includes a plurality of aeration units, wherein each of the aeration units include a base, an aeration plate 4014 arranged at the bottom of the retaining wall type fermentation region, and an aeration head 4015 in communication with the retaining wall type fermentation region 30;

the base includes two sub bases 4011 arranged opposite to each other, and an air inlet channel is formed between the two sub bases 4011:

each two adjacent aeration units are spliced to each other;

the aeration plate 4014 is located between the two sub bases 4011 and is detachably mounted to the two sub bases 4011 respectively; and

the aeration plate 4014 is provided with an air hole, the aeration head 4015 corresponding to the air hole is detachably mounted on the aeration plate 4014, and the aeration head 4015 is in communication with the air hole.

According to the solid waste treatment system of the present application, in the process of performing aeration by the aeration unit 401, a gas source first enters the air inlet channel, and enters the aeration head 4015 through the air hole, and is aerated by an aeration hole of the aeration head 4015.

In each two adjacent aeration units, one side of the sub base 4011 is provided with a slot 4012, another side of the sub base 4011 is provided with a protrusion 4013 matching with the slot 4012, and the slot 4012 of the sub base 4011 is insertingly connected with the protrusion 4013 of the adjacent sub base 4011. The aeration plate 4014 and the sub base 4011 may be threadedly or insertingly connected, and the aeration head 4015 and the aeration plate 4014 may be threadedly or insertingly connected.

The aeration unit 401 further includes a support column 4016, the supporting column 4016 is detachably connected with the aeration plate 4014 to support the aeration plate 4014, and the support column 4016 may assist the base to support the aeration plate 4014.

According to one solution of the solid waste treatment system of the present application, as shown in FIG. 1, the storage device 10 includes an auxiliary material buffer region 101, a sludge buffer region 102 and a finished material buffer region 103 which are independent from one another.

According to the solid waste treatment system of the present application, the storage device 10 includes the auxiliary material buffer region 101, the sludge buffer region 102 and the finished material buffer region 103, the above three regions are independently arranged and will not affected by one another. The auxiliary material buffer region 101 is used to store auxiliary materials required for fermentation, the sludge buffer region 102 is used to store the sludge required for fermentation, and the finished material buffer region 103 is used to store finished materials required for fermentation, so that the auxiliary materials, sludge and finished materials can be stored differently, and thereby improving the effect of solid waste treatment.

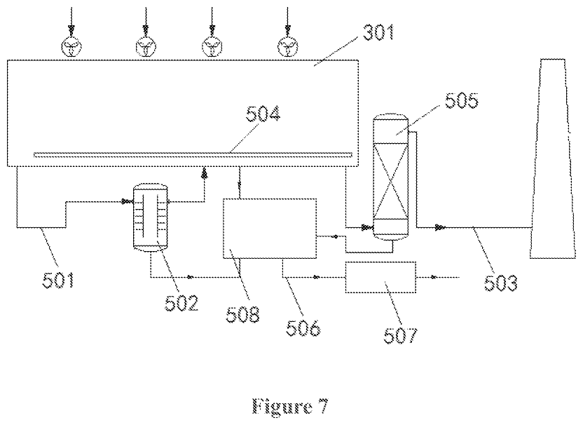

According to one solution of the solid waste treatment system of the present application, as shown in FIG. 7, the solid waste treatment system further includes a purification device 50, an outlet of the purification device 50 is in communication with the aeration platform 40, and an outlet of the purification device 50 is in communication with the retaining wall type fermentation region 30.

According to the solid waste treatment system of the present application, specifically, the purification device 50 includes a plurality of first suction devices, a first pipeline 501 and a gas-water separator 502. The plurality of first suction devices and the gas-water separator 502 are connected in series in the first pipeline 501 and are all in communication with the first pipeline 501. The retaining wall type fermentation region 30 is in communication with the gas-water separator 502 to allow the hot and humid gas generated in the retaining wall type fermentation region 30 to be sent into the gas-water separator 502 via the first suction devices for gas-water separation. The gas-water separator 502 is in communication with the aeration platform 40 to allow the hot gas separated by the gas-water separator 502 to be sent to the aeration platform 40 via the first suction devices for aeration.

For the solid waste treatment system, the materials in the retaining wall type fermentation region 30 perform aerobic fermentation, and a large amount of hot and humid gas is generated during the fermentation process, which remains in the retaining wall type fermentation region 30. The hot and humid gas is suctioned from the retaining wall type fermentation region 30 to the gas-water separator 502 by the first suction devices for gas-water separation, and the hot gas is obtained. The hot gas is suctioned from the gas-water separator 502 into the aeration platform 40 by the first suction devices for aeration and replenishment, so that the materials in the retaining wall type fermentation region 30 can perform the aerobic fermentation. Since the heat of the hot and humid gas is retained in the hot gas, the heat carried by the hot gas may make the retaining wall type fermentation region 30 with low outdoor environment such as being in cold winter and the north area in China have a good fermentation effect, which allows the heat carried by the hot gas to be further utilized, thereby saving the energy and avoiding the waste caused by directly discharging the heat to the outside atmosphere. The first suction devices are induced draft fans, which are not shown in FIG. 7, and valves in the first pipeline 501 are also not shown in FIG. 7.

The purification device 50 further includes a plurality of second suction devices, a second pipeline 503, a waste gas collection pipe 504 and a washing tower 505. The plurality of second suction devices, the waste gas collection pipe 504 and the washing tower 505 are connected in series in the second pipeline 503 and are all in communication with the second pipeline 503. The waste gas collection pipe 504 is mounted in the retaining wall type fermentation region 30, and the waste gas collection pipe 504 is in communication with the washing tower 505, so that the waste gas in the retaining wall type fermentation region can be sent to the washing tower 505 via the second suction devices for treatment.

After prolonged and multiple times of fermentation in the retaining wall type fermentation region 30, the waste gas in the retaining wall type fermentation region 30 is required to be discharged to the outside atmosphere, so as to purify the gas in the retaining wall type fermentation region 30. Therefore, the waste gas in the retaining wall type fermentation region 30 may be sent to the washing tower 505 via the waste gas collection pipe 504 and the second suction devices, to be discharged to the outside atmosphere after being treated to reach the standards. The second suction devices are induced draft fans, which are not shown in FIG. 7, 10, and valves in the second pipeline 503 are also not shown in FIG. 7.

The purification device 50 further includes a plurality of third suction devices, a plurality of third pipelines 506, a water processor 507, and a water collection tank 508. Each of the third suction devices is connected to one of the third pipelines 506. The water collection tank 508 is in communication with the retaining wall type fermentation region, the gas-water separator 502 and the washing tower 505 through three third pipelines 506 respectively, to collect condensed water in the retaining wall type fermentation region, separated water in the gas-water separator 502 and washing water in the washing tower 505 through the third suction devices. The water processor 507 is in communication with the water collection tank 508 through another one of the third pipelines 506, so that the water collected in the water collection tank 508 can be discharged after being treated to reach the standards.

After prolonged and multiple times of fermentation in the retaining wall type fermentation region, a large amount of condensed water is generated therein. The condensed water contains waste water produced by fermentation, and there are also waste water in the gas-water separator 502 and the washing tower 505. The condensed water in the retaining wall type fermentation region 30, the condensed water in the gas-water separator 502 and the condensed water in the washing tower 505 may be sent into the water processor 507 for purification treatment, and then discharged after reaching the standards. The third suction devices are water pumps, which are not shown in FIG. 7, and valves in the third pipelines 506 are also not shown in FIG. 7.

According to one solution of the solid waste treatment system of the present application, as shown in FIG. 1, the solid waste treatment system further includes a fermentation cabin 60; wherein

the fermentation cabin 60 covers the storage device 10, the intelligent aerobic fermentation treatment device 20, the retaining wall type fermentation region 30, the aeration platform 40 and the purification device 50; and

the intelligent aerobic fermentation treatment device 20 is slidably connected with a bottom surface of the fermentation cabin 60.

According to the solid waste treatment system of the present application, the fermentation cabin 60 may play the functions of airtighting, heat preservation and rain proofing. Preferably, the fermentation cabin 60 employs a thermal insulation material for absorbing the solar energy or employs solar photovoltaic panels, so as to better play the heat preservation function.

The bottom surface of the fermentation cabin 60 is provided with a slide rail along which the traveling bridge 201 may move.

According to one solution of the solid waste treatment system of the present application, the traveling trolley 202 includes a fixed frame, a top of the fixed frame is fixedly connected with the upper frame 2031, and a bottom of the fixed frame is configured to travel on the traveling bridge 201.

According to the solid waste treatment system of the present application, the traveling bridge 201 includes a main beam, a support leg and a bottom beam. A top of the main beam of the traveling bridge is provided with a first rail, the bottom of the fixed frame is provided with first wheels, and the first wheels travel on the first rail. With the first wheels, a speed of the fixed frame moving on the traveling bridge 201 is increased.

In addition, a bottom of the traveling trolley 202 is further provided with multiple monitoring and sensing elements, to monitor multiple data parameters in the fermentation process.

Besides, the support leg of the traveling bridge 201 is provided with second wheels, the bottom surface of the fermentation cabin 60 is provided with a second rail, and the second wheels travel along the second rail. With the second wheels, a speed of the traveling bridge moving in the fermentation cabin 60 is increased.

Finally, it should be noted that the above embodiments are only intended to describe the technical solutions of the disclosure, but not to limit the scope of the disclosure. Although the disclosure is described in detail with reference to the above embodiments, it should be understood by those ordinal skilled in the art that modifications can be made to the technical solutions recorded in the above embodiments or equivalent replacements can be made to some or all of the technical features thereof, which modifications and equivalent replacements will not make the corresponding technical solutions deviate from the scope of the technical solutions of the embodiments of the disclosure.

1. A solid waste treatment system, comprising:
a storage device;
an intelligent aerobic fermentation treatment device;
a retaining wall type fermentation region;
a purification device;
a fermentation cabin; and
an aeration platform; wherein
the intelligent aerobic fermentation treatment device comprises a traveling trolley, a lifting mechanism, a material pick-up and discharge mechanism, and a traveling cart configured to move linearly along a direction from the storage device to the retaining wall type fermentation region;
the aeration platform is arranged at a bottom of the retaining wall type fermentation region;
the traveling trolley is configured to move linearly on the traveling cart along a direction perpendicular to the direction from the storage device to the retaining wall type fermentation region;
the lifting mechanism is arranged at the traveling trolley, and the lifting mechanism comprises an upper frame, a lower frame, a scissor structure and a first driving mechanism; the upper frame being arranged at the traveling trolley; the lower frame being connected with the upper frame through the scissor structure; and the first driving mechanism being connected with the scissor structure;
the material pick-up and discharge mechanism is hung on the lower frame, to be lifted or lowered together with the lower frame;
an outlet of the purification device is in communication with the aeration platform, and an inlet of the purification device is in communication with the retaining wall type fermentation region;
the purification device comprises a plurality of first suction devices, a first pipeline and a gas-water separator;
the plurality of first suction devices and the gas-water separator are connected in series in the first pipeline and are all in communication with the first pipeline;
the retaining wall type fermentation region is in communication with the gas-water separator, to facilitate a hot and humid gas generated in the retaining wall type fermentation region to be sent into the gas-water separator by the first suction devices for gas-water separation;
the gas-water separator is in communication with the aeration platform, to allow a hot gas separated by the gas-water separator to be sent to the aeration platform by the first suction devices for aeration; and
the fermentation cabin is arranged to cover the storage device, the intelligent aerobic fermentation treatment device, the retaining wall type fermentation region, the aeration platform and the purification device.

2. The solid waste treatment system according to claim 1, wherein the material pick-up and discharge mechanism comprises a storage hopper, a plurality of pick-up shovels, a transmission chain structure, and a second driving mechanism; and wherein
the storage hopper comprises a hopper body with an opened top, and a discharge door;
the discharge door is movably arranged at a bottom of the hopper body;
the hopper body is hung on the lower frame;
the plurality of pick-up shovels are arranged around the hopper body via the transmission chain structure; and
the transmission chain structure is connected with the second driving mechanism.

3. The solid waste treatment system according to claim 1, wherein the retaining wall type fermentation region comprises a closed fence type retaining wall, and wherein the retaining wall type fermentation region is defined by the fence type retaining wall.

4. The solid waste treatment system according to claim 3, wherein the fence type retaining wall comprises a plurality of sub retaining walls fixedly connected with the ground, and wherein the plurality of sub retaining walls are connected to one another to form the closed fence type retaining wall.

5. The solid waste treatment system according to claim 1, wherein the aeration platform comprises a plurality of aeration units, each of the aeration units comprising a base, an aeration plate arranged at the bottom of the retaining wall type fermentation region, and an aeration head in communication with the retaining wall type fermentation region; and wherein
the base comprises two sub-bases arranged opposite to each other, and an air inlet channel is formed between the two sub-bases;
each two adjacent ones of the plurality of aeration units are spliced to each other;
the aeration plate is located between the sub-bases and is detachably mounted on the two sub-bases; and
the aeration plate is provided with an air hole, the aeration head which corresponds to the air hole is detachably mounted on the aeration plate, and the aeration head is in communication with the air hole.

6. The solid waste treatment system according to claim 1, wherein the storage device comprises an auxiliary material buffer region, a sludge buffer region, and a finished material buffer region which are independent from one another.

7. The solid waste treatment system according to claim 1, wherein the intelligent aerobic fermentation treatment device is configured to travel on a bottom surface of the fermentation cabin.
